(19) United States
(12) Patent Application Publication
(10) Pub. No.: US 2014/0300462 A1
(43) Pub. Date: Oct. 9, 2014

(54) Trunk Lid Hazard Warning/Signaling Device

(71) Applicant: Derek Terrell Russ, (US)

(72) Inventor: Derek Terrell Russ, Gretna, LA (US)

(21) Appl. No.: 13/858,065

(22) Filed: Apr. 7, 2013

(51) Int. Cl. B60Q 1/46

(52) U.S. Cl. CPC B60Q 1/46
USPC 340/471

(57) ABSTRACT

The present invention generally relates to a vehicle trunk lid and an improved hazard warning/signaling device, more particularly, to a vehicle trunk lid hazard warning/signaling device wherein a housing and a housing frame are sized and adapted for mounting upon the underneath side of the vehicle trunk lid which said device can be quickly and easily displayed upon activation of a vehicle's remote trunk release and upon engagement of a vehicle's hazard flashing system, or the like. The trunk lid hazard warning/signaling device is adapted to operate in concert with the vehicle's hazard flashing system and remote trunk release. The device can be utilized to direct traffic at any time during the day or night by warning the occupant of an on-coming vehicle that a vehicle stands on the road in his way.

### CROSS-REFERENCE TO RELATED APPLICATIONS

This application claims the benefit of provisional patent application No. 61/589,877, filed 2012 Jan. 24 by the present inventor.

### BACKGROUND

### Description of Prior Art

The present invention generally relates to an improved hazard warning/signaling device, more particularly, to a trunk lid hazard warning/signaling device, for a vehicle(s) which becomes temporarily effective upon activation of the vehicle's remote trunk release and upon engagement of the vehicle's hazard flashing system, or the like, which places the device in a displayed position for other highway vehicles. The device becomes an essential safety alert when the vehicle stands on any road, in the way of an on-coming vehicle, where there may be danger of collision with said on-coming vehicle, and danger of personal injury to the occupant of said on-coming vehicle. The device can be quickly and easily withdrawn by closing the vehicle's trunk lid and deactivating the vehicle's hazard flashing system. The trunk lid hazard warning/signaling device can be mounted by new car, van and sports utility vehicles manufacturers as original, standard or upgrade equipment. The device can also be made available in an aftermarket kit form for installation by individual purchasers. Preferably, the device is lightweight, affordable and adaptable to a wide variety of cars, vans and sports utility vehicles.

There are known hazard warning/signaling devices for use on vehicles, an example of which is a hazard flashing system, in which emergency light flashers are attached to the lower portions of a vehicle. A disadvantage of this type of warning device is that it is not easily seen in the day time and can be readily obstructed by persons standing on the road working around the vehicle. Other known hazard warning/signaling devices have included reflective triangles, flashing lights or beacons, strobe lights, and flashing or sequentially illuminated directional arrows.

It has been proposed to provide a safety warning signal for automotive vehicles, trucks, trailers, and other objects, concealed within the lid of a trunk of an automobile or attached to or beneath the rear of a truck, trailer or the like. The device requires manual assembly, as disclosed in U.S. Pat. No. 3,255,725.

It has further been proposed to permanently attach a warning sign to the rear of an automobile in such a way that it is hidden, for example, in the rear compartment when the automobile is in normal use and that it becomes visible when, for example, the cover of the rear compartment is opened. The conventional structure, particularly the means for mounting the warning sign on the rear part of the automobile are complicated and expensive to make and install, as disclosed in U.S. Pat. No. 3,430,374.

It has further been proposed to provide a warning device for vehicles having a rear portion, the device comprised of a rectangular warning sign made of a flexible sheet material having upper and lower edge portions. The attachment means are individually removably connected to the rear of said vehicle when the device is being displayed. The device requires manual assembly, as disclosed in U.S. Pat. No. 3,594,938.

It has further been proposed to permanently mount a sheet of material such as paperboard, wood, metal, plastic or other similar material upon which symbols and messages of caution may be spray painted or otherwise applied by stenciling, which said sheet may then be mounted on the inner surface of a cover in the rear compartment and illuminated by projecting light against the sign. The warning device is greatly attenuated and does not provide the visibility that the present invention does, as disclosed in U.S. Pat. No. 4,044,482.

It has further been proposed to temporarily attach a warning apparatus, which features an arrow that requires changing to point left or right, for mounting on the trunk of an automobile in such a way that it is hidden, for example, in the rear compartment when the automobile is in normal use and that it becomes visible when, for example, removed from the rear compartment and set up. The warning apparatus requires manual assembly as disclosed in U.S. Pat. No. 5,103,205.

It has further been proposed to provide a safety banner device which can cover any metallic area of a vehicle, such as, but not limited to, the front, sides, top, bottom, rear, or trunk whether open or closed. The device is comprised of at least on piece of banner material whose shape could be circular, square, rectangular or any other shape known. The device requires manual assembly, as disclosed in U.S. Pat. No. 5,398,437.

It has further been proposed to temporarily mount a device comprised of a highly reflective arrowhead traffic sign that can be shaped into a configuration that point to both the left and right. The device requires manually assembly and is mounted on the side or body of a vehicle, as disclosed in U.S. Pat. No. 7,370,602.

It has further been proposed to provide an emergency signaling device comprised of a flexible substrate stowed in the trunk of a vehicle for extending from a folded position to an extended position, for conveying a message to motorists approaching a vehicle. The emergency signaling device may extend from the trunk of the vehicle upon activation of a remote trunk release when a hazard flasher system is on. The emergency device may be removed from the vehicle for use as an emergency signaling device. The device requires manual assembly, as disclosed in U.S. Pat. No. 7,404,372.

### OBJECTS AND SUMMARY

The present invention provides a trunk lid hazard warning/signaling device whose housing and housing frame are sized and adapted for mounting upon the underneath side of a vehicle trunk lid that can be utilized to direct traffic at any time during the day or night. A feature of the invention is that an illuminable high-visibility light source of the trunk lid hazard warning/signaling device may be powered by a vehicle's battery, generator or internal backup battery located in the device's housing. Therefore, the risk of the light source not having power or losing power is kept to a minimum. Should the illuminating means fail, such as would be the case if the vehicle's battery were inoperative, the device's internal backup battery would engage.

All safety and law enforcement vehicles have enjoyed safety features of hazard lights that are substantially visible on roads and highways. Personal motor vehicles should also enjoy these safety features in a practical manner, although it would not be an aesthetically appeasing and commercially successful design element if vehicle designers were to design hazard lights in the same manner as an external component of the vehicles' design, excepting lights that motor vehicles currently utilize. An added, practical, and easy to employ trunk lid hazard warning/signaling device would enhance the hazard flashing system of any vehicle's current system and is of a size and character to be visible at a great distance.

In view of the above, it is an object of the present invention, among others, to provide a trunk lid hazard warning/signaling device, which becomes temporarily effective upon activation of the vehicle's remote trunk release and upon engagement of the vehicle's hazard flashing system, or the like, which places the device in a displayed position for other highway vehicles. The device carries the illuminable high-visibility light source used to warn the occupant of an on-coming vehicle that the vehicle stands on the road in his way where there may be danger of collision with said on-coming vehicle, and danger of personal injury to the occupant of said on-coming vehicle.

It is a further object of the present invention to provide an improved hazard warning/signaling device which can be quickly and easily installed to the cover of the rear compartment of any new passenger car, fastback, station wagon or truck without making any alteration of the device.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention. Other objects and advantages of the invention will be apparent from the following brief description and better understood by those skilled in the art when taken in conjunction with the accompanying drawings:

### BRIEF DESCRIPTION OF THE DRAWINGS

FIG. 1A shows a front elevational view of one embodiment of the trunk lid hazard warning/signaling device mounted upon the underneath side of an automobile trunk lid in a displayed position.

FIG. 1B shows a front elevational view of one embodiment of the trunk lid hazard warning/signaling device mounted upon the underneath side of an automobile trunk lid in a displayed position.

FIG. 2A shows a front elevational view of one embodiment of the trunk lid hazard warning/signaling device.

FIG. 2B shows a front elevational view of one embodiment of the trunk lid hazard warning/signaling device.

FIG. 3 shows a left elevational view of one embodiment of the trunk lid hazard warning/signaling device.

FIG. 4A shows a front elevational view of one embodiment of the trunk lid hazard warning/signaling device mounted adjacent to an inside surface of a van or SUV hatch in a displayed and opened position.

FIG. 4B shows a front elevational view of one embodiment of the trunk lid hazard warning/signaling device mounted adjacent to an inside surface of a van or SUV hatch in a displayed and opened position.

FIG. 5A shows a front elevational view of one embodiment of the trunk lid hazard warning/signaling device in a displayed and opened position.

FIG. 5B shows a front elevational view of one embodiment of the trunk lid hazard warning/signaling device in a displayed and opened position.

FIG. 5C shows a front elevational view of one embodiment of the trunk lid hazard warning/signaling device in a displayed and opened position.

FIG. 6 shows a bottom side view of one embodiment of the trunk lid hazard warning/signaling device in a closed position.

FIG. 7A shows a bottom side view of one embodiment of the trunk lid hazard warning/signaling device in an opened position.

FIG. 7B shows a bottom side view of one embodiment of the trunk lid hazard warning/signaling device in an opened position.

FIG. 7C shows a bottom side view of one embodiment of the trunk lid hazard warning/signaling device in an opened position.

FIG. 8A shows a left elevational view of one embodiment of the trunk lid hazard warning/signaling device in an opened position pivoting in the direction indicated by the arrow.

FIG. 8B shows a left elevational view of one embodiment of the trunk lid hazard warning/signaling device in a closed position.

FIG. 9A shows a left elevational view of one embodiment of the trunk lid hazard warning/signaling device in an opened position pivoting in the direction indicated by the arrow.

FIG. 9B shows a left elevational view of one embodiment of the trunk lid hazard warning/signaling device in a closed position.

FIG. 10 shows a frontal view of one embodiment of the housing of the trunk lid hazard warning/signaling device.

FIG. 11 shows an electrical schematic in accordance with the trunk lid hazard warning/signaling device.

Reference Numerals

10 trunk lid hazard warning/signaling device
12 housing
14 housing frame
16 attachment means
18 securing means
20 light source
22 light source
24 light source
26 light source
28 light source
30 light source
32 electric circuit
34 wire
36 wire
38 car battery and/or generator, P
40 internal backup battery, P
42 wire
44 vehicle

### EMBODIMENTS

### Description

The present invention provides an improved hazard warning/signaling device for a vehicle whose housing and housing frame are sized and adapted for mounting upon the underneath side of a vehicle trunk lid that can be utilized to direct traffic at any time during the day or night. A feature of the invention is that an illuminable high-visibility light source of the trunk lid hazard warning/signaling device may be powered by a vehicle's battery, generator or internal backup battery located in the device's housing. Therefore, the risk of the light source not having power or losing power is kept to a minimum. Should the illuminating means fail, such as would be the case if the vehicle's battery were inoperative, the device's internal backup battery would engage.

In view of the above, it is an object of the present invention, among others, to provide a trunk lid hazard warning/signaling device. This device carries the illuminable high-visibility light source used to warn the occupant of an on-coming vehicle that the vehicle stands on the road in his way; that there may be danger of collision with said on-coming vehicle; and that there may be danger of personal injury to the occupant of said on-coming vehicle.

It is a further object of the present invention to provide a trunk lid hazard warning/signaling device which can be quickly and easily installed to the cover of the rear compartment of any new passenger car, fastback, station wagon or truck without making any alteration of the device.

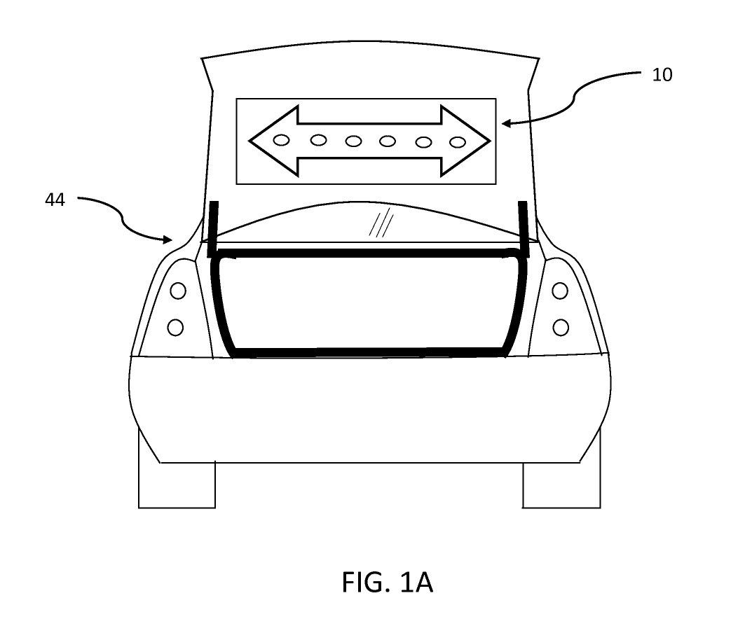

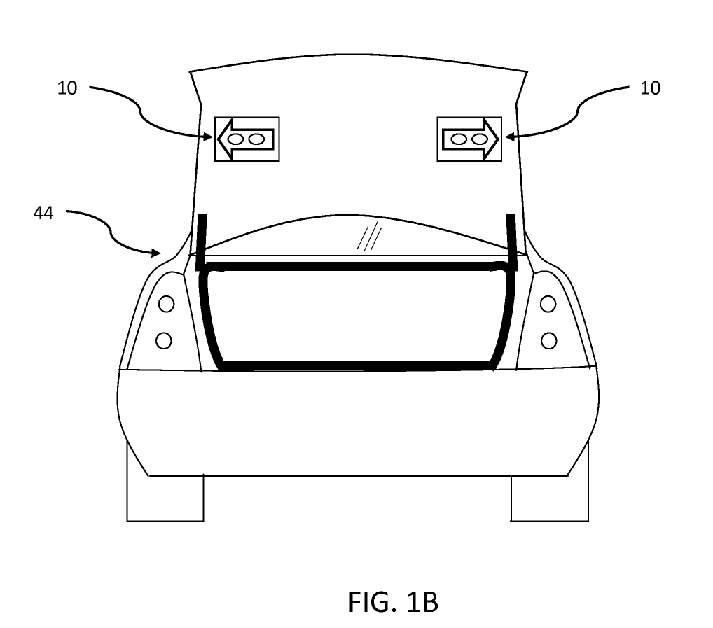

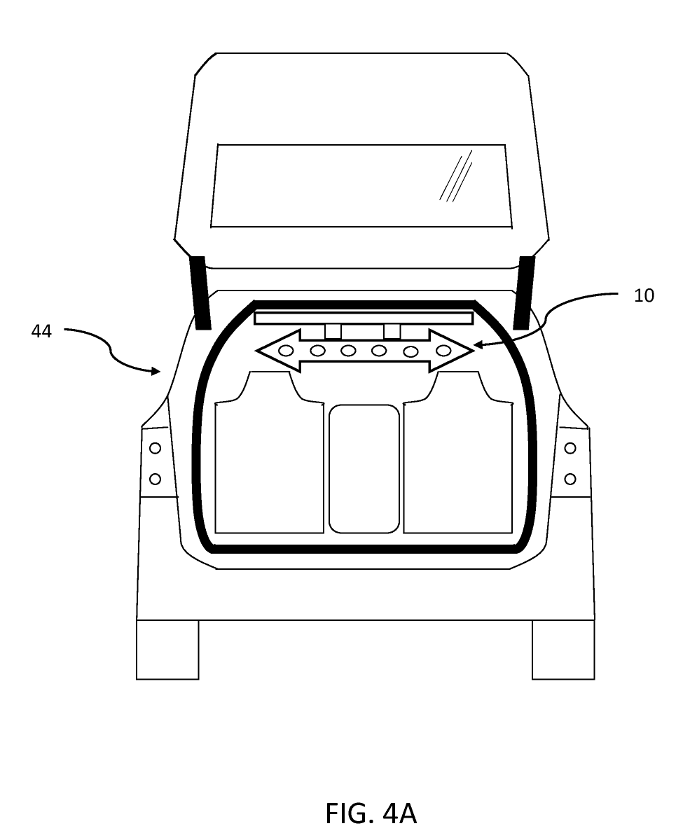

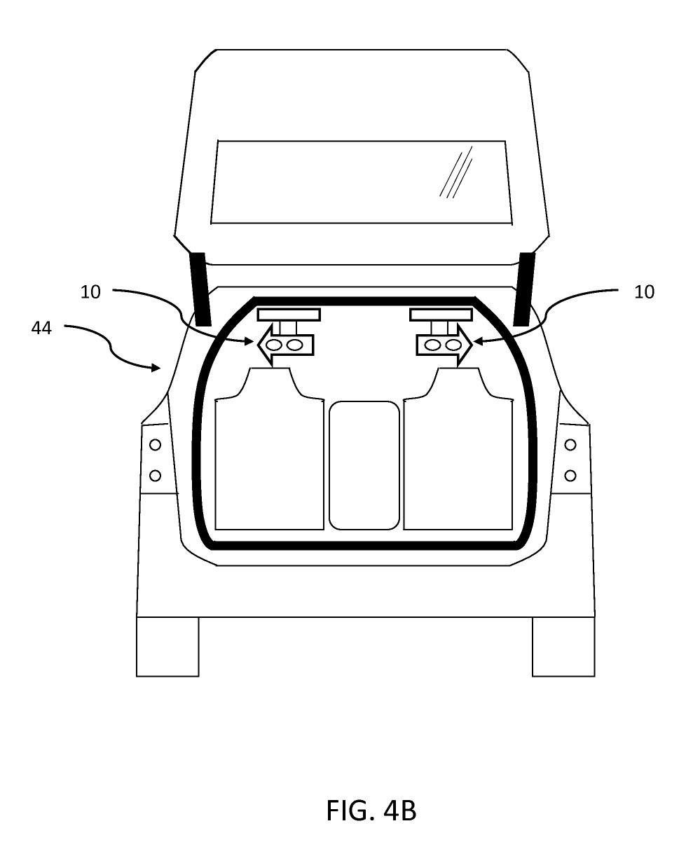

The trunk lid hazard warning/signaling device is preferably mounted on or adjacent to the inside surface of the rear opening fixture of a vehicle, such as a trunk lid, hitch door, or tailgate. In one embodiment, the device is sized and adapted for mounting inside a vehicle trunk or hatch. Preferably, the subject invention can be installed upon the underneath side of the trunk lid, as shown in FIGS. 1A and 1B. In a van or sports utility vehicle, the device is preferably placed in the ceiling over the rear seat, as shown in FIGS. 4A and 4B. In the case of a van or sports utility vehicle with rear doors, the device could also be applied to the rear ceiling. In the case of a truck, the device is preferably placed in the rear of the tailgate. This would position the device in a displayable position when the vehicle stands on any road in the way of other vehicles where there may be danger of collision with an on-coming vehicle, and danger of personal injury to the occupant of said on-coming vehicle.

In one embodiment of the invention, the device is readily exposed for use when a user opens the rear opening fixture of a vehicle. The trunk lid hazard warning/signaling device becomes temporarily effective upon activation of the vehicle's remote trunk release and upon engagement of the vehicle's hazard flashing system, or the like.

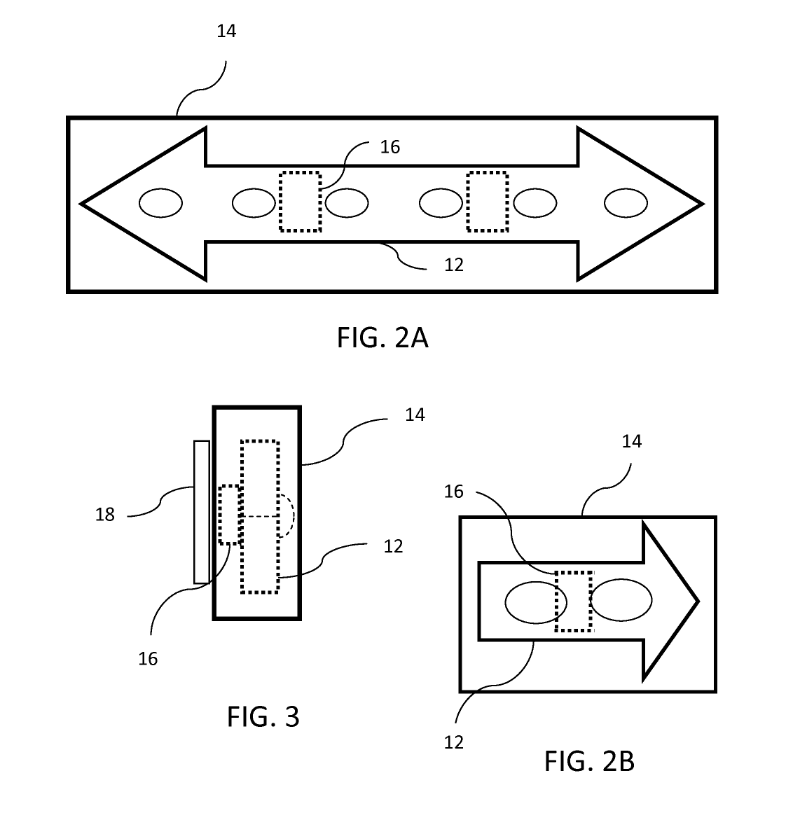

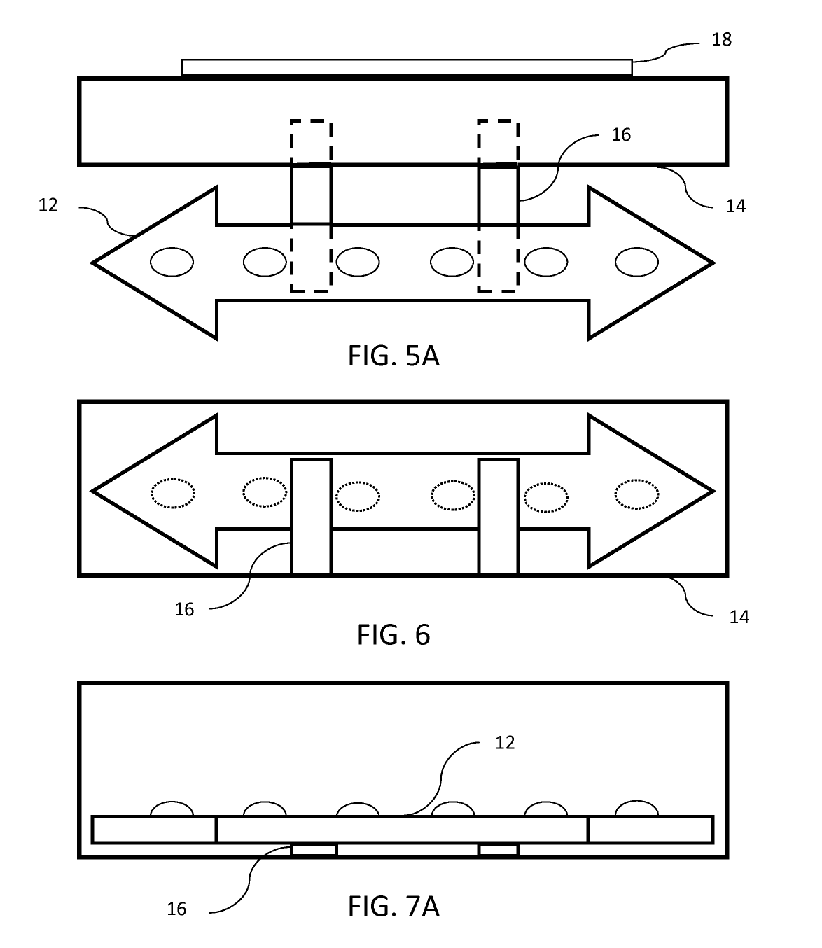

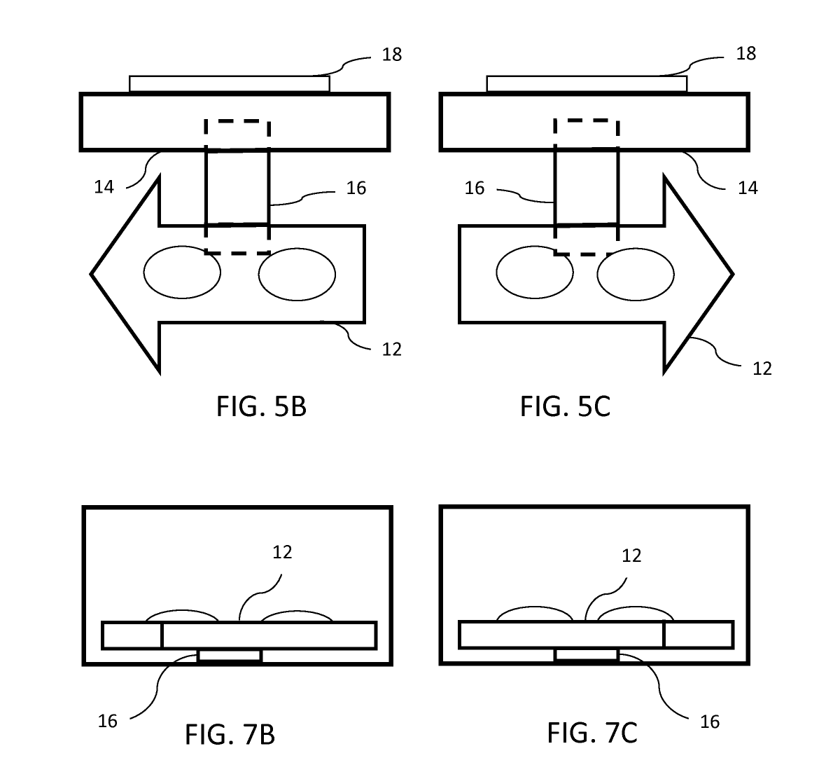

In one embodiment, a housing 12 and a housing frame 14 occupy one of two positions, a traveling position or an operative position, depending upon the status of the trunk lid, i.e., closed or opened, respectively, as shown in FIGS. 2A, 2B and 3. In another embodiment, a securing means 18 of the housing frame 14 provides the flexibility to cooperate with the interior structure of the rear opening fixture such that, when the rear opening fixture is closed, the housing 12 and the housing frame 14 are in a stowed or traveling position wherein the housing 12 and the housing frame 14 does not significantly intrude into the cargo space of the rear opening fixture, as shown in FIGS. 6, 8B, and 9B. Conversely, when the rear opening fixture is in an opened position, the housing 12 is oriented within the housing frame 14 to provide an on-coming vehicle facing the open trunk or hatch area with a view of the trunk lid hazard warning/signaling device 10, as shown in FIGS. 5A, 5B, 5C, 7A, 7B, 7C, 8A, and 9A. This cooperation among the housing 12, the housing frame 14, and the rear opening fixture may be achieved by one or more securing means 18 for securing the subject invention to one or more surfaces within the vehicle, whether said cooperation amongst the housing 12, the housing frame 14, and the rear opening fixture is electronically adjustable or automated. The securing means 18 may be, for example, an adhesive or magnet, depending upon the ferrous content of the surface that the subject invention is to be secured to. The securing means 18 may function in a temporary or permanent fashion, and may even be integral to the paneling of the vehicle's interior. It will be appreciated that any number of other suitable securing means can also be used. Examples of other securing means include clips, clamps, pegs, hook and loop fasteners, screw fasteners, rivets, straps, springs, brackets or suction cups. It will be additionally appreciated that the securing means may also include a hinge or ball and socket joint to permit flexibility in the orientation of the housing frame 14 for optimal visibility.

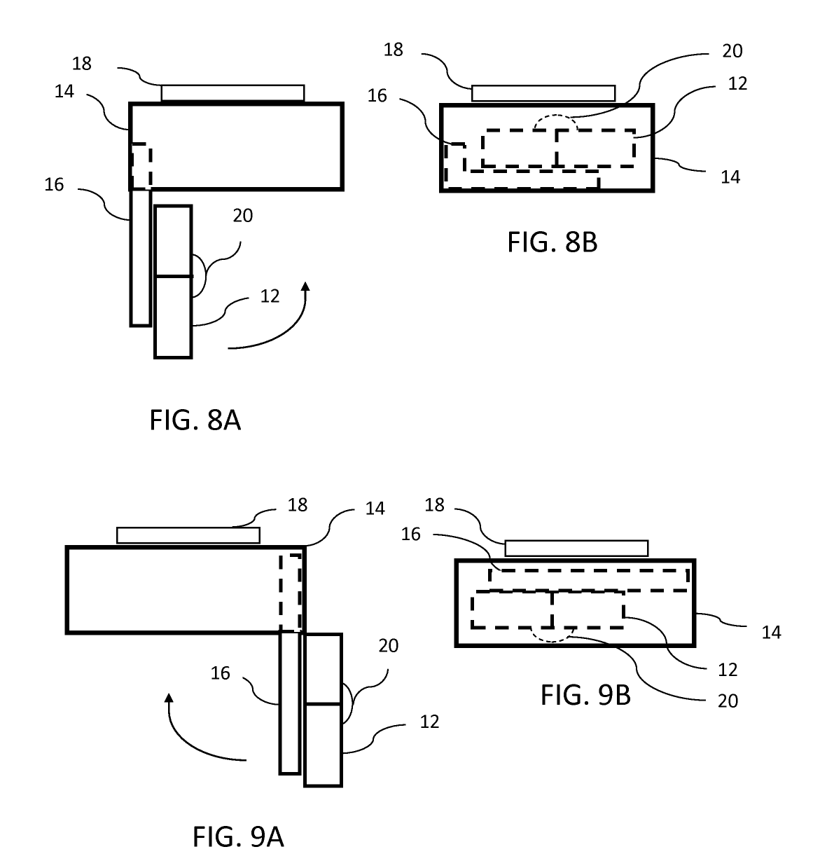

The housing 12 of the subject invention can have one or more attachment means 16 for attaching the housing 12 to the housing frame 14. The attachment means 16 may be, for example, an adhesive or magnet, depending upon the ferrous content of the surface that the housing 12 is to be attached to, as shown in FIGS. 2A, 2B, and 3. The attachment means 16 may also be a hinged arm pivoting in the direction indicated by the arrow, as shown in FIGS. 8A and 9A. The attachment means 16 may function in a temporary or permanent fashion. It will be appreciated that any number of other suitable attachment means can also be used. Examples of other attachment means include clips, clamps, pegs, hook and loop fasteners, screw fasteners, rivets, straps, springs, brackets or suction cups. In addition, the attachment means may include a hinge or ball and socket joint to permit flexibility in the orientation of the housing 12 within the housing frame 14. This cooperation among the housing 12, housing frame 14, and the attachment means 16 may be achieved, for example, by the cooperation of a hinge and folded elements, as disclosed in U.S. Pat. No. 5,762,245, which teaches a folding trunk tray, or by the cooperation of a hinge or ball and socket joint to permit flexibility in the orientation of the housing 12 within the housing frame 14, as disclosed in U.S. Pat. No. 6,485,156, or by the cooperation of an automated hinge assembly having two leaves with a driving member, as disclosed in U.S. Pub. Nos.: US2010/0101147 and US2009/0229080, whether said cooperation among the housing 12, housing frame 14, and the attachment means 16 is electronically adjustable or automated.

The subject invention concerns a vehicle trunk lid, hatch door, tailgate, or roof area comprising a trunk lid hazard warning/signaling device 10 mounted on the inside of the lid, hatch door, or roof area such that when the same is opened the device 10 is positioned in a manner to allow an on-coming vehicle facing the opened trunk lid, hatch door, tailgate, or roof area with a view of the trunk lid hazard warning/signaling device 10, as shown in FIGS. 1A, 1B, 4A, and 4B.

The subject invention also concerns a vehicle, such as an automobile, van, or sports utility vehicle, which comprises a trunk lid hazard warning/signaling device 10 of the present invention mounted or otherwise provided at the rear of the vehicle such that an on-coming vehicle facing the rear of the vehicle, such as when the trunk or hatch is open, is visible to the on-coming vehicle.

The subject device 10 can be mounted by new car, van, and sports utility vehicles manufacturers as original, standard, or upgrade equipment. It can also be made available in an aftermarket kit form for installation by individual purchasers. Preferably, the device is lightweight, affordable, and adaptable to a wide variety of cars, vans and sports utility vehicles.

In one embodiment of the invention, the device 10 comprises a housing 12 which can be made of durable material such as plastic, e.g., injection-molded polypropylene, polyethylene, or high density polyethylene. Other materials, such as aluminum and steel, are also contemplated. The housing 12 can be utilized during the day or at night with its illuminable high-visibility light sources 20, 22, 24, 26, 28, and 30 that may be designed to illuminate continuously, intermittently, sequentially, or the like by a light emitting diode (LED) controller (not shown) to appear to move animatedly in a certain direction. This cooperation between the illuminable high-visibility light sources 20, 22, 24, 26, 28, and 30 and the LED controller may be achieved, for example, as disclosed in U.S. Pat. App. No. US2010/0085181, which teaches a multi-color, multi-functional light bar. The device 10 comprises the housing 12 which is mounted in the housing frame 14 which can also be made of durable material such as plastic, e.g., injection-molded polypropylene, polyethylene, or high density polyethylene. Other materials, such as aluminum and steel, are also contemplated.

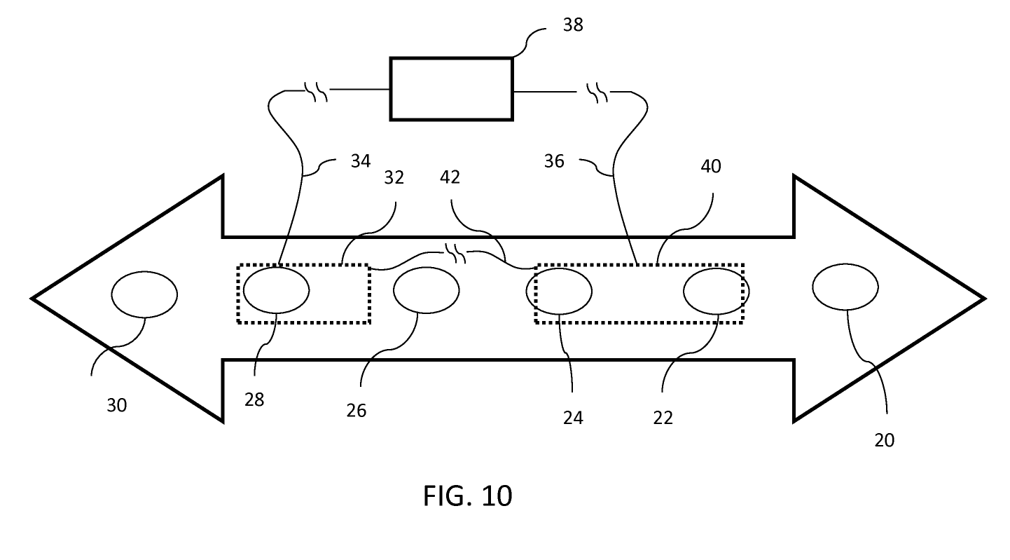

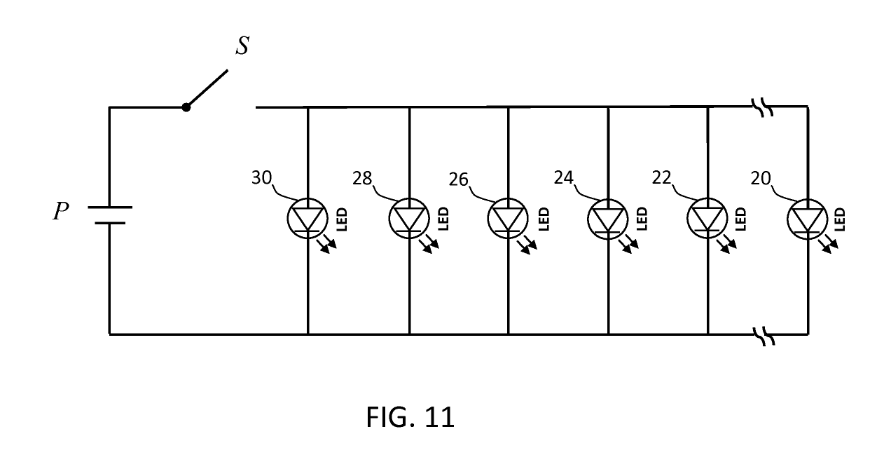

Additionally, as shown in FIG. 10, the housing 12 contains illuminable high-visibility light sources 20, 22, 24, 26, 28 and 30 which are electrically connected to an electric circuit 32, which is electrically connected to a wire 34 and a wire 42, which are electrically connected to a vehicle battery and/or generator 38 and an internal backup battery 40, respectively. The vehicle battery and/or generator 38 are electronically connected to a wire 36, which is electrically connected to the internal backup battery 40. This connection provides a charge to the internal backup battery 40 in the event the vehicle's battery becomes disabled. The illuminable high-visibility light sources 20, 22, 24, 26, 28, and 30 are connected in parallel to one another with reference to the electrical power source P, as shown in FIG. 11. In this way, if one illuminable high-visibility light source 20, 22, 24, 26, 28 or 30 were to fail, the rest of the illuminable high-visibility light sources would remain lit. However, it can be readily seen by one of ordinary skill in the art that a number of ways of electrically connecting the illuminable high-visibility light sources may be employed. For example, the illuminable high-visibility light sources 20, 22, 24, 26, 28, and 30 may be connected in series if so desired, or some combination of series and parallel connections. A switch S is connected in series with the illuminable high-visibility light sources 20, 22, 24, 26, 28, and 30 in order to electrically connect the illuminable high-visibility light sources 20, 22, 24, 26, 28, and 30 to the electrical source P, as shown in FIG. 11.

The trunk lid hazard warning/signaling device 10 may be directly wired to the vehicle's electrical system, represented by the electrical power source P. In this configuration, the switch S would be a manual control switch that would be within easy reach of the driver to turn the trunk lid hazard warning/signaling device 10 on and off by connecting the illuminable high-visibility light sources 20, 22, 24, 26, 28, and 30 to the electrical power source P as needed.

Although the illuminable high-visibility light sources 20, 22, 24, 26, 28, and 30 are shown as individual lights, it will be appreciated that any number of other illuminating devices can also be used. Examples of other illuminating devices are fluorescent lamps, high intensity light emitting diodes, one continuous light source, or the like.

The trunk lid hazard warning/signaling device 10 may further include a global positioning system (GPS) transmitter (not shown) to allow the vehicle 44 to be located on the road when broken down. The GPS may be electrically connected in series with the switch S so that when the trunk lid hazard warning/signaling device 10 is switched on, the GPS will transmit the location of the vehicle 44 to facilitate aid in arriving. In this configuration, the GPS transmitter may be wired to the electrical power source P of the vehicle 44. However, additional methods of powering the GPS transmitter can readily be seen by one of ordinary skill in the art. For instance, the GPS transmitter may include its own power supply, such as a battery.

In view of the foregoing disclosure, some of the advantages of the present invention can be seen. For instance, a novel trunk lid hazard warning/signaling device is disclosed. Although the invention has been shown and described with respect to exemplary embodiments thereof, various other changes, omissions, and additions in form and detail thereof may be made therein without departing from the spirit and scope of the invention.

Thus the scope of the embodiments should be determined by the appended claims and their legal equivalents, rather than by the examples given. All patents, patent applications, provisional applications, and publications referred to or cited herein are incorporated by reference in their entirety to the extent they are not inconsistent with the explicit teachings of this specification.

Having thus described the invention, what is claimed as being new and desired to be protected by Letters Patent of the United States is as follows:

1. A rear opening fixture of a vehicle comprising:
a trunk lid hazard warning/signaling device with a housing having a line segment with, or without, a wedge shaped head at each distal end, forming the shape of a two-headed arrow, said heads including a pair of arms extending outwardly along either side of said line segment to form an angle therewith, said housing sized and adapted for mounting, in a housing frame, on or adjacent to an inside surface of the rear opening fixture comprising a directional indicator means for indicating to an on-coming motorist a preferred traffic flow direction around said vehicle when said rear opening fixture of said vehicle is in an opened position thereby placing said trunk lid hazard warning/signaling device in a displayed and an opened position, with said trunk lid warning/signaling device having at least one illuminable high-visibility light source.
a trunk lid hazard warning/signaling device with a housing having a line segment with, or without, a wedge shaped head at a distal end, forming the shape of a one-headed arrow, said head including a pair or arms extending outwardly along either side of said line segment to form an angle therewith, said housing sized and adapted for mounting, in a housing frame, on or adjacent to an inside surface of the rear opening fixture comprising a directional indicator means for indicating to an on-coming motorist a preferred traffic flow direction around said vehicle when said rear opening fixture of said vehicle is in an opened position thereby placing said trunk lid hazard warning/signaling device in a displayed and an opened position, with said trunk lid warning/signaling device having at least one illuminable high-visibility light source.

2. The rear opening fixture of claim 1, wherein said rear opening fixture is selected from the group consisting of a trunk lid, hatch door, tailgate and roof area of the vehicle.

3. The rear opening fixture according to claim 1, wherein said housing is made of a material selected from the group consisting of plastic, injection-molded polypropylene, polyethylene, high density polyethylene, aluminum, and steel.

4. The rear opening fixture according to claim 1, wherein said device can occupy either of two positions, a traveling position or an operative position, wherein said traveling position of said device is achieved when said rear opening fixture is closed and said operative position is achieved when said rear opening fixture is opened, wherein in the operative position said directional indicator means indicates to the on-coming motorist the preferred traffic flow direction around said vehicle.

5. The rear opening fixture according to claim 3, wherein said housing is mounted in said housing frame made of a material selected from the group consisting of plastic, injection-molded polypropylene, polyethylene, high density polyethylene, aluminum, and steel.

6. The rear opening fixture according to claim 3, wherein said housing has one or more attachment means for attaching the housing to the housing frame, said attachment means comprising, for example, an adhesive, magnet, clips, clamps, pegs, hook and loop fasteners, screw fasteners, rivets, straps, springs, brackets, suction cup, or a hinge or ball and socket joint to permit flexibility in the orientation of the housing within the housing frame, wherein said flexibility may also be achieved, for example, by the cooperation of a hinge and folded elements, whether said attachment means are electronically adjustable or automated and whether said attachment means function in a temporary or permanent fashion.

7. The rear opening fixture according to claim 5, wherein said housing frame has a securing means for securing said device on or adjacent to the inside surface of the rear opening fixture of the vehicle, said securing means comprising, for example, an adhesive, magnet, clips, clamps, pegs, hook and loop fasteners, screw fasteners, rivets, straps, springs, brackets, suction cups, or a hinge or ball and socket joint to permit flexibility in the orientation of the housing frame, whether said securing means are electronically adjustable or automated and whether said securing means function in a temporary or permanent fashion.

8. The rear opening fixture according to claim 3, wherein said housing further comprises a plurality of said light sources defining said segment and/or said heads and an electric circuit electrically connected to said light sources, and powered by said vehicle's battery and/or generator or by said device's internal backup battery.

9. The rear opening fixture according to claim 8, wherein said housing further comprises flashing lights.

10. The rear opening fixture according to claim 8, wherein the trunk lid hazard warning/signaling device further comprises a light emitting diode controller, wherein the plurality of said light sources are animated by the light emitting diode controller for displaying animated warning for directing said on-coming vehicle away from the vehicle.

11. The rear opening fixture according to claim 1 wherein the trunk lid hazard warning/signaling device is adapted to operate in concert with the vehicle's hazard flashing system and remote trunk release.
